(19) United States
(12) Patent Application Publication
(10) Pub. No.: US 2014/0229031 A1
(43) Pub. Date: Aug. 14, 2014

(54) Micro-Inverter Based AC-Coupled Photovoltaic Microgrid System with Wireless Smart-Grid Controls

(71) Applicant: Petra Solar, Inc., South Plainfield, NJ (US)

(72) Inventors: Ruba Akram Amarin, Piscataway, NJ (US); Ghaith Haddad, Piscataway, NJ (US); Hussam Alatrash, South Plainfield, NJ (US); Imran Ahmed Bhutta, Moorestown, NJ (US)

(73) Assignee: Petra Solar, Inc., South Plainfield, NJ (US)

(21) Appl. No.: 14/181,009

(22) Filed: Feb. 14, 2014

Related U.S. Application Data
(60) Provisional application No. 61/764,566, filed on Feb. 14, 2013.

(51) Int. Cl. H02J 3/00

(52) U.S. Cl. CPC H02J 3/00
USPC 700/295

(57) ABSTRACT

A microgrid and methods for managing the microgrid are disclosed. A microgrid controller may determine an amount of energy generated by each of a plurality of distributed energy resources connected to the microgrid. The microgrid controller may determine an amount of energy required to power each of a plurality of loads connected to the microgrid. The microgrid controller may alter, based on the determined amount of energy generated by the each of the plurality of distributed energy resources and the amount of energy required to power each of the plurality of loads connected to the microgrid, a status of at least one of the plurality of loads connected to the microgrid.

### BACKGROUND

Over the past few years technological innovations, changing economic conditions, changing regulatory environments, shifting of environmental conditions, and social priorities have spurred interest in Distributed Generation (DG) systems. Distributed Generation is a new model for power systems that is based on the integration of small and medium-sized generators into a utility grid. For example, a microgrid is a localized grouping of energy generation sources, energy storage units, and loads. Microgrids may operate connected to a traditional centralized grid via a common coupling. When disconnected from the centralized grid, microgrid may support the loads from the energy generated by the energy generation sources and the energy stored in the energy storage units.

### SUMMARY OF THE INVENTION

A microgrid and methods of managing resources of the microgrid are disclosed. The microgrid may be an alternating current (AC) coupled microgrid which may be interconnected to a utility grid. The microgrid may be interconnected to the utility grid via an AC coupling. When disconnected from the utility grid, the microgrid may be capable of supporting electrical loads through energy generation sources, for example, distributed renewable resources and energy storage units. The microgrid may be a self sufficient grid, and may become a distributed generation and storage resources from the utility's perspective.

### BRIEF DESCRIPTION OF THE DRAWINGS

The accompanying drawings, which are incorporated in and constitute a part of this disclosure, illustrate various embodiments of the present invention. In the drawings:

FIG. 1 is a diagram of a microgrid architecture;

FIG. 2 is a diagram of a layered management approach for a microgrid;

FIG. 3 is a diagram of a microgrid controller; and

FIG. 4 is a flow diagram of a method for managing a microgrid.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Embodiments of the disclosure may provide a microgrid and a method to manage the microgrid. More specifically, the disclosure provides an alternating current (AC) coupled microgrid which may be interconnected to a utility grid. The microgrid may be interconnected to the utility grid via an AC coupling. When disconnected from the utility grid, the microgrid may be capable of supporting electrical loads through energy generation sources and energy storage units. For example, the microgrid may incorporate renewable energy sources and energy storage devices to support the electrical loads forming a self sufficient grid. The microgrid, when connected to the utility grid, may become distributed generation and storage resources from the utility's perspective. The microgrid may be remotely managed and controlled from a centralized location.

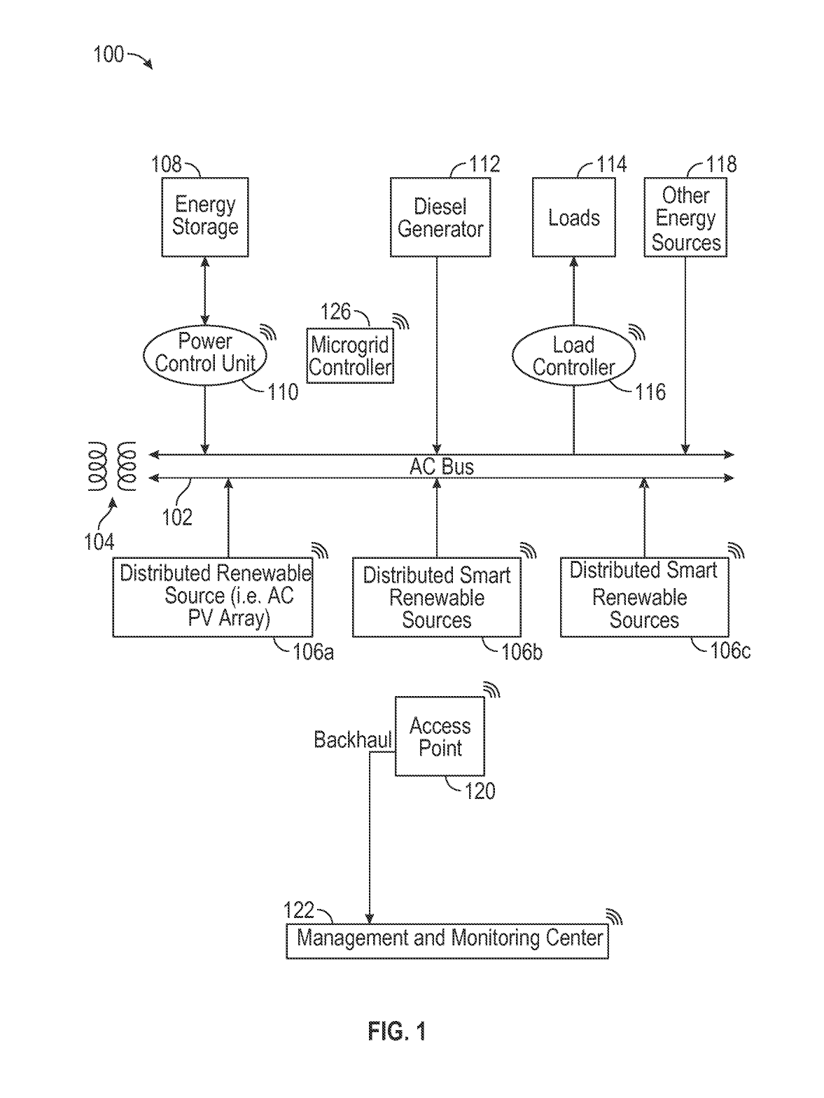

FIG. 1 is a schematic diagram of a microgrid 100. Microgrid 100 may be an independent local microgrid architecture system, which may be interconnected to a utility grid. Microgrid 100 may include an AC bus 102, a coupler 104, distributed renewable resources 106a, 106b, 106c (collectively referred to as DRS 106), an energy storage 108, a power control unit 110, a diesel generator 112, loads 114, a load controller 116, other energy sources 118, an access point 120, a management and monitoring center 122, and a microgrid controller 126. As shown in FIG. 1, microgrid 100 may be an AC coupled system, where various resources on microgrid 100 may interchange power using standard wiring and voltages designed for alternating current. The exchange of power using standard wiring and voltages may allow the installation of microgrid 100 with minimal (or no) rewiring. For example, AC bus 102 may have a defined voltage and frequency. The voltage and the frequency of AC bus 102 may be defined by a microgrid administrator, and may be defined to be compliant with microgrids standards, such as UL1741.

Coupler 104 may be configured to connect or disconnect and reconnect microgrid 100 from the utility grid. For example, in case power loss from the utility grid, coupler 104 may disconnect microgrid 100 from the utility grid. Similarly, on restoration of power from the utility grid, coupler 104 may reconnect microgrid 100 to the utility grid. Coupler 104 may be programmed to sense the power flow in the utility grid, and connect/disconnect microgrid 100 to the utility grid based on the sensed power flow. When disconnected from the utility grid, microgrid 100 may be configured to support loads 114 by at least one of DRS 106, energy storage 108, diesel generator 112, and other energy resources 118.

DRS 106 may be configured to generate power locally. For example, DRS 106 may be a renewable energy resource, such as a solar panel, a wind mill, etc. The energy generated by DRS 106 may be provided to AC bus 102. For example, DRS 106 may be connected to AC bus 102 through micro-converters (not shown). The micro-converters may control the flow of power from DRS 106 to AC bus 102. For example, micro-converters may be programmed to control the voltage and frequency of the power. Micro-converters may be programmed by the microgrid administrator.

In addition to DRS 106, power may be provided to AC bus 102 from energy storage 108. For example, energy storage 108 may be a battery configured to store electrical energy. Energy storage 108 may be configured to provide power to AC bus 102 at a constant rate. Energy storage 108 may be connected to AC bus 102 through power control unit 110. Power control unit 110 may be configured to control the rate of flow of power from energy storage 108. Energy storage 108 may further be configured to absorb power from AC bus 102 through power control unit 110. Power control unit 110 may be configured by a system administrator.

Additional amount of power may be provided to AC bus 102 from diesel generator 112 and other energy sources 118. For example, diesel generator 112 may be configured to provide power to AC bus 102 when the amount of energy generated by DRS 106 is not sufficient to power loads 114. In some scenario, other energy sources 118 may be connected to microgrid 100 to provide additional power. Microgrid controller 126 may control addition of diesel generator 112 and other energy sources 118 to AC bus 102. For example, microgrid controller 126 may add diesel generator 112 to AC bus 102 to power critical loads connected to microgrid 100.

Loads 114 may be connected to AC bus 102 through load controller 116. Load controller 116 may be configured to connect and disconnect loads 114 to AC bus 102. Load controller 116 may be controlled by microgrid controller 126 or may operate on its own in master-less mode. For example, microgrid controller 126 may send commands to load controller 116 to disconnect non-critical loads from microgrid 100. Loads 114, DRS 106, energy storage 108, diesel generator 112, and other energy resources 118 may seamlessly be added or removed to microgrid 100 with no disruption to the operations of critical loads.

Each resources of microgrid 100, such as DRS 106, energy storage 108, diesel generator 112, loads 114, and other energy resources 118 may include communication protocol interface (CPI) widgets, which may enable each resource to communicate wirelessly, regardless of its built-in communication protocol. Each resources, may communicate, either directly or indirectly (hoping through another resource), with access point 120. The communication between resources and access point 120 may be established wirelessly through ZigBee, WiFi, power-line communications, GSM, Fiber, or any other reliable communication protocol.

Access point 120 may collect data from the resources and send the collected data to management and monitoring center 122. Management and monitoring center 122 may provide a platform to monitor and control microgrid 100. Management and monitoring center 122 may be a network operation center (NOC). Management and monitoring center 122 may be located remotely from microgrid 100 and may be integrated with grid management systems, such as SCADA systems and smart grid systems. Backhaul communication between access point 120 and Management and monitoring center 122 may be established through ZigBee, WiFi, power-line communications, GSM, Fiber, or any other reliable communication protocol. Access point 120 may include a memory device to temporarily store the operational data received from the resources. Access point 120 may further be configured to receive communication from management and monitoring center 122. Access point 120 may forward communication received from management and monitoring center 122 to the resources of microgrid 100.

Microgrid controller 126 may be configured to control operations of microgrid 100. For example, microgrid controller 126, also referred to as energy management system (EMS), may communicate wirelessly with each resources of microgrid 100 ensuring a proper operation. Health and status of DRS 106, energy storage 108, and loads 114 may be monitored in real time by microgrid controller 126. Microgrid controller 126 may be programmed so that the operation of microgrid 100 may meet specific requirements such as, energy cost optimization, battery health or carbon footprint. For instance, noncritical loads may be turned off to protect the battery's health.

Microgrid controller 126 may be used to orchestrate generation, storage, and loads within a locality to behave as a coherent microgrid. Furthermore, each resource may be equipped with intelligence that may allow microgrid 100 to function in a master-less fashion. In a grid-tied setting, microgrid controller 126 may negotiate directly or indirectly with a grid management system. The objective of this negotiation may be to enhance voltage stability on the grid, and realize the economic objectives of microgrid 100. Microgrid controller 126 may have control over coupler 104 at the point of common coupling (PCC) to the utility grid that may behave as an intelligent gateway. Coupler 104, may be dubbed as a smart switch, may enable the isolation of microgrid 100 where it is operated in island-mode, maintaining power supply to loads 114.

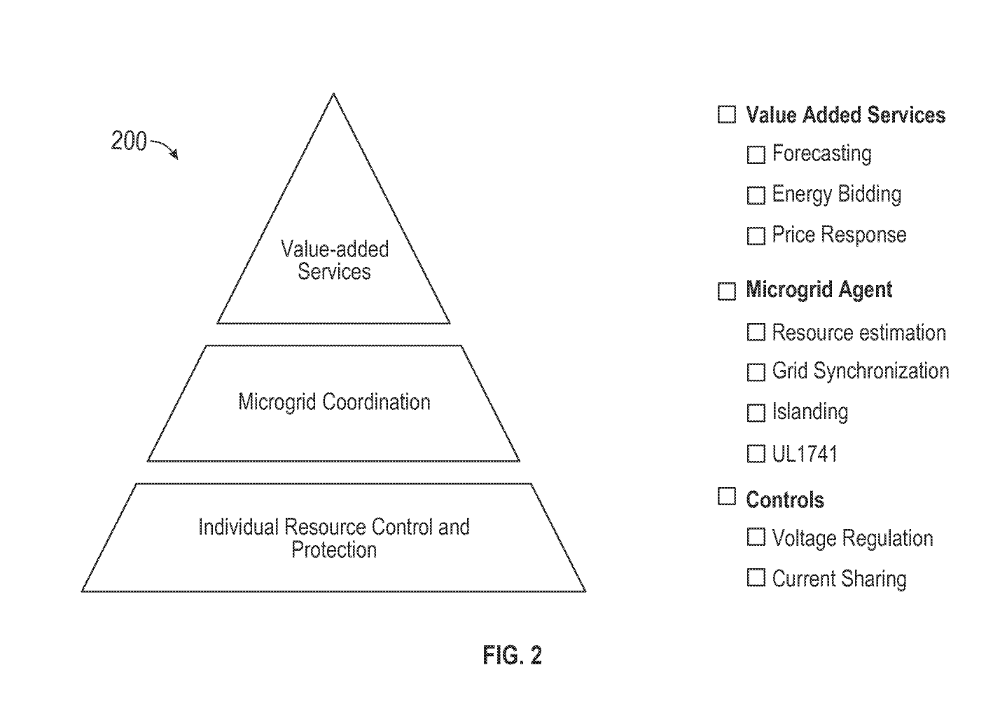

In one embodiment, microgrid 100 may be operated based on a layered management approach. The layered management approach may simplify operation of microgrid 100. For example, the layered management approach may reduce requirements for fast and reliable communications. An example of the layered management approach is shown in FIG. 2. For example, and as shown in FIG. 2, a plurality of layers of management may be defined for microgrid 100. In a first layer, which may be the highest priority layer of operation, a voltage regulation and current sharing of microgrid 100 may be managed. In a second layer, resource estimation, grid synchronization, islanding and compliance of microgrid 100 may be managed. In a third layer, forecasting, energy bidding and price response may be managed. The layered management approach may further allow individual resources to operate in a safe default mode if microgrid controller 126 or the communication network is faulted. Small microgrids may be coordinated to form larger microgrids. Larger microgrids may form mini-grids, and mini-grids may form sub-grids.

In one embodiment, microgrid 100 may be configured to operate in a master-less fashion. For example, microgrid 100 may have an increased reliability since the resources of microgrid 100 may operate in the master-less fashion. Microgrid 100 may rely on resources capable of operating in parallel while collectively regulating the voltage and frequency in the master-less fashion. The master-less mode of operation may allow microgrid 100 to continue operation even in the event of multiple resource failure, as long as enough energy is available for critical loads. In addition, the master-less mode of operation may facilitate flexible scalability if the load requirements are to increase in the future. Furthermore, the master-less mode of operation may allow the possibility of connecting seamlessly to other microgrids or the national grid if/when such connection is available. To enable microgrid 100 to operate in the master-less mode of operation, each resource of microgrid 100 may be equipped with an intelligent control interface.

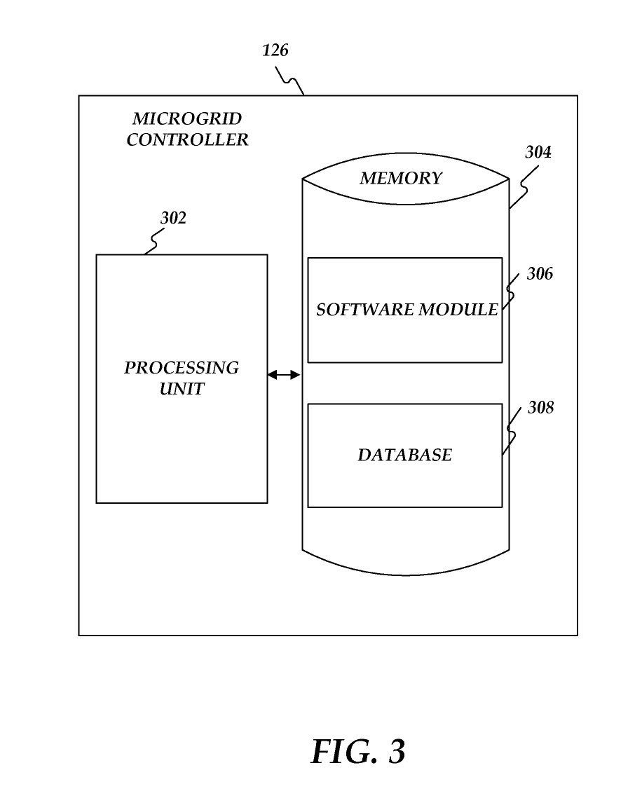

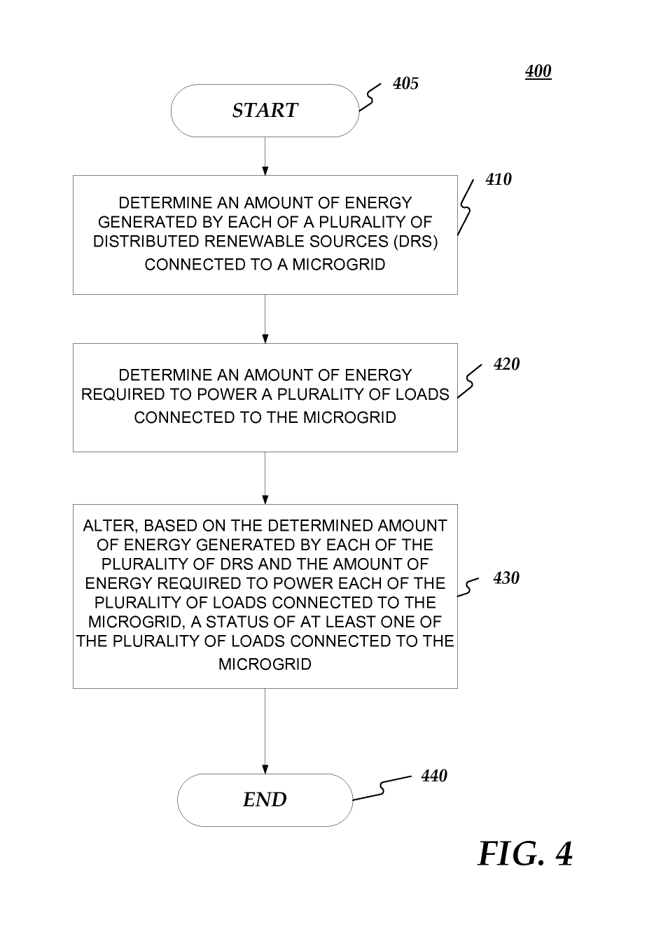

FIG. 3 shows microgrid controller 126 in more detail. As shown in FIG. 3, microgrid controller 126 may include a processing unit 302 and a memory unit 304. Memory unit 304 may include a software module 306 and a database 308. While executing on processing unit 302, software module 306 may perform processes for managing and controlling operations of microgrid 100, including for example, any one or more of the stages from method 400 described below with respect to FIG. 4.

Furthermore, any software module 306 and database 308 may be executed on or reside in any element shown in FIG. 1.

Microgrid controller 126 (“the processor”) may be implemented using a Wi-Fi access point, a cellular base station, a tablet device, a mobile device, a smart phone, a telephone, a remote control device, a set-top box, a digital video recorder, a cable modem, a personal computer, a network computer, a mainframe, a router, or other similar microcomputer-based device. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise, for example, a mobile terminal, such as a smart phone, a cellular telephone, a cellular telephone utilizing wireless application protocol (WAP) or unlicensed mobile access (UMA), personal digital assistant (PDA), intelligent pager, portable computer, a hand-held computer, a conventional telephone, or a wireless fidelity (wi-fi) access point. The aforementioned systems and devices are examples and the processor may comprise other systems or devices.

FIG. 4 is a flowchart setting forth the general stages involved in a method 400 consistent with an embodiment of the invention for management and control of microgrid 100. Method 400 may be implemented using microgrid controller 126, as described above with respect to FIG. 3. Ways to implement the stages of method 400 will be described in greater detail below. Method 400 may begin at starting block 405 and proceed to stage 410 where microgrid controller 126 may determine an amount of energy generated by each of a plurality of distributed renewable sources (DRS) 106 connected to microgrid 100. For example, microgrid controller 126 may receive energy generation data from each of DRS 106 connected to microgrid 100, and determine a total amount of energy generated by DRS 106. Microgrid controller 126 may determine the amount of energy, in case of loss of power from the utility grid.

Form stage 410, where microgrid controller 126 determines the amount of energy generated by each of the plurality of DRS 106, method 400 may advance to stage 420 where microgrid controller 126 may determine an amount of energy required to power loads 114 connected to microgrid 100. For example, microgrid controller 126 may determine amount of energy required to power up both critical and non-critical loads connected to microgrid 100.

From stage 420, where microgrid controller 126 determines the amount of energy required to power the plurality of loads 114 connected to microgrid 100, method 400 may advance to stage 430 where microgrid controller 126 may alter, based on the determined amount of energy generated by the each of the plurality of DRS 106 and the amount of energy required to power loads 114 connected to microgrid 100, a status of at least one of loads 114. For example, microgrid controller 126 may determine amount of energy required to power both critical and non-critical loads. Further microgrid controller 126 may determine if the amount of energy generated by DRS 106 is sufficient to power both the critical and non-critical loads. If the amount of energy generated by DRS 106 is not sufficient to power both the critical and non-critical loads, microgrid controller 126 may determine whether to disconnect the non-critical loads from microgrid 100 or provide additional power by connecting energy storage 108 to microgrid 100. For example, microgrid controller 126 may based on the amount of power required to power the critical and non-critical loads, may disconnect non-critical loads if the available power from DRS 106 is not enough. In some instance, microgrid controller 126 may provide additional power by adding diesel generator 112 to microgrid 100. In some other instance, if power generated by DRS 106 is more than the power required to power loads 114, microgrid controller 126 may connect energy storage 108 to store the surplus power. After microgrid controller 126 alters status of the at least one loads 114 connected to microgrid 100 in stage 430, method 400 may then end at stage 440.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the internet, or other forms of ram or rom. Further, the disclosed methods' stages may be modified in any manner, including by reordering stages and/or inserting or deleting stages, without departing from the invention.

All rights including copyrights in the code included herein are vested in and the property of the applicant. The applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method of managing a microgrid, the method comprising:
determining an amount of energy generated by each of a plurality of distributed energy resources (DERs) connected to a microgrid;
determining an amount of energy required to power each of a plurality of loads connected to the microgrid; and
altering, based on the determined amount of energy generated by the plurality of distributed energy resources and the amount of energy required to power each of the plurality of loads connected to the microgrid, a status of at least one of the plurality of loads connected to the microgrid.

2. The method of claim 1, wherein determining the amount of energy generated by each of the plurality of DERs connected to the microgrid comprises determining the amount of energy generated by each of the plurality of DERs connected to the microgrid in response to loss of power to the microgrid from an electrical grid.

3. The method of claim 1, further comprising altering based on the determined amount of energy generated by the each of the plurality of distributed energy resources and the amount of energy required to power each of the plurality of loads connected to the microgrid, a status of at least one of the plurality of DERs connected to the microgrid.

4. The method of claim 3, wherein altering the status of the at least one of the plurality of DERs comprises connecting a diesel generator unit to the microgrid.

5. The method of claim 3, wherein altering the status of the at least one of the plurality of DERs comprises connecting an energy storage unit to the microgrid.

6. The method of claim 5, wherein connecting the energy storage unit to the microgrid comprises connecting the energy storage unit to the microgrid wherein the energy storage unit is a battery.

7. The method of claim 1, wherein altering the status of the at least one of the plurality of loads comprises disconnecting non-critical loads to from the microgrid.

8. The method of claim 1, wherein determining the amount of energy generated by each of the DERs connected to the microgrid comprises determining the amount of energy generated by each of the DERs connected to the microgrid wherein at least one of the plurality of DERs is a renewable energy resource.

9. The method of claim 1, further comprising operating the microgrid in a master-less fashion.

10. A microgrid system comprising:
an alternating current (AC) bus;
a plurality of distributed energy resources (DERs) connected to the AC bus;
at least one load connected to the AC bus; and
a microgrid controller configured to:
determine loss of power from an electrical grid to the microgrid,
determine, in response to the loss of power from the electrical grid, an amount of energy generated by the plurality of DERs,
determine, an amount of energy required to support the at least one load, and
alter, based on the determined amount of energy produced by the plurality of DERs and the amount of energy required to support the at least one load, status of one of: at least one of the plurality of DERs and the at least one load.

11. The microgrid of claim 10, wherein the microgrid further comprises a coupler configured to couple and decouple the microgrid to an utility grid.

12. The microgrid of claim 11, wherein each of the plurality of DERs further comprises a micro-inverter.

13. The microgrid of claim 12, wherein the micro-inverter is configured to control a voltage and frequency of flow of power from the plurality of DERs to the microgrid.

14. The microgrid of claim 10, wherein the microgrid further comprises a monitoring station to monitor operations of the microgrid.

15. The microgrid of claim 14, wherein the monitoring station is located remote to the microgrid.

16. The microgrid of claim 10, wherein the microgrid operates in a master-less fashion.

17. The microgrid of claim 10, wherein the plurality of DERs are renewable energy resources.

18. The microgrid of claim 10, wherein the microgrid controller is configured to remove non-critical loads from the microgrid.

19. The microgrid of claim 10, wherein the microgrid further comprises an energy storage unit to power critical loads during loss of power from the plurality of DERs.

20. A system for managing distributed energy resources, the system comprising:
a memory; and
a processor coupled to the memory, the processor configured to:
determine an amount of energy generated by each of a plurality of distributed energy resources (DERs) connected to a microgrid;
determine an amount of energy required to power each of a plurality of loads connected to the microgrid; and
alter, based on the determined amount of energy generated by the each of the plurality of distributed energy resources and the amount of energy required to power each of the plurality of loads connected to the microgrid, a status of at least one of the plurality of loads connected to the microgrid.
